(19) United States
(12) Patent Application Publication
(10) Pub. No.: US 2025/0232532 A1
(43) Pub. Date: Jul. 17, 2025

(54) Augmented Reality System for Network Management

(71) Applicant: Cisco Technology, Inc., San Jose, CA (US)

(72) Inventors: Ashok K. Moghe, Pleasanton, CA (US); Hari Pillai, San Jose, CA (US); Avinash Kalyanaraman, San Francisco, CA (US)

(21) Appl. No.: 18/414,318

(22) Filed: Jan. 16, 2024

(51) Int. Cl. G06T 19/00; G01S 13/06; G06F 21/32; G06F 21/62

(52) U.S. Cl. CPC G06T 19/006; G01S 13/06; G06F 21/32; G06F 21/6218

(57) ABSTRACT

Devices, networks, systems, methods, and processes for an Augmented Reality (AR) based device management. An AR device of the present disclosure can receive an image from a camera. The image may depict one or more objects. The AR device can determine device position data, including a position and an orientation, of the AR device. The AR device can identify the one or more objects in the image based on the device position data. The AR device may identify one or more controllers associated with the objects. The AR device can retrieve control data associated with the objects from the one or more controllers. The AR device may superimpose the control data on the image to generate an augmented image. The AR device can display the augmented image to a user. The AR device may further generate one or more control signals associated with the one or more objects.

The present disclosure relates to Augmented Reality (AR) systems. More particularly, the present disclosure relates to AR devices for management of digital infrastructure.

### BACKGROUND

In digital infrastructure, systems such as communication networks, data centers, power delivery networks, and electrical networks utilize a large number of interconnected devices. In these systems, connections between the devices are usually complex and dense. Such systems often provide a centralized controller that assists an operator with a logical view of the devices and the connections between the devices. However, while such centralized controllers can help in visualizing the devices and functional parameters of the devices, actual process of locating the devices and the connections is not very easy. For instance, in a server room, a large number of switches or routers are hosted in many stacks located side by side. In these stacks of switches, every switch may be connected to a different server or can belong to a different owner. Since all switches may look visually similar, differentiating between the switches can be very tricky and time consuming. In this case, for obtaining the functional parameters such as power consumption or operational states of the switches, the operator has to manually inspect the switches, distinguish between the switches, and then lookup the functional parameters in the centralized controller.

Conventional Augmented Reality (AR) devices, such as head mounted smart glasses or consoles, overlay information on images obtained by the AR devices through cameras. However, such information is passive information that is stored into the AR devices or in a user device that is connected to the AR devices. In context of managing the digital infrastructure, the conventional AR devices lack the ability to identify and provide relevant information related to the digital infrastructure. Furthermore, the conventional AR devices are often confined to specific applications, such as, for instance, immersive gaming, and can only provide predetermined information related specifically to these applications. While the images displayed by the AR devices are graphically appealing, they merely serve as a supplementary layer for passive data augmentation. Therefore, the conventional AR devices fail to provide solutions to management problems faced by most systems in the digital infrastructure.

Therefore, there is a need for dynamic and interactive AR systems that can be utilized to interact, control, or manage physical devices.

### SUMMARY OF THE DISCLOSURE

Systems and methods for AR devices for management of digital infrastructure in accordance with embodiments of the disclosure are described herein.

In some embodiments, an augmented reality logic may be configured to receive an image, determine device position data, identify one or more objects visible in the image based on the device position data, obtain control data corresponding to the one or more objects, and generate an augmented image by superimposing the control data on the image.

In some embodiments, the augmented reality logic is further configured to access an object identification database, transmit an identification request indicative of the device position data to the object identification database, receive identification data from the object identification database in response to the identification request, and identify the one or more objects visible in the image based on the identification data.

In some embodiments, the augmented reality logic is further configured to receive biometric data, authenticate a user of the device based on the biometric data, and determine a user identifier corresponding to the user.

In some embodiments, the augmented reality logic is further configured to access an administrative database, transmit an access control request indicative of the user identifier to the administrative database, and receive access control data from the administrative database in response to the access control request.

In some embodiments, the augmented reality logic is further configured to identify one or more controllers associated with the one or more objects, transmit one or more status requests to the one or more controllers, and receive the control data from the one or more controllers in response to the one or more status requests.

In some embodiments, the one or more status requests are indicative of the identification data corresponding to the one or more objects, and the access control data corresponding to the user.

In some embodiments, the identification data is indicative of one or more of three-dimensional positional coordinates corresponding to the one or more objects, object identifiers corresponding to the one or more objects, or controllers associated with the one or more objects.

In some embodiments, the augmented reality logic is further configured to generate one or more control signals corresponding to the one or more objects based on the control data.

In some embodiments, the augmented reality logic is further configured to receive an input from the user and generate the one or more control signals based on the control data and the input.

In some embodiments, the augmented reality logic is further configured to transmit the one or more control signals to the one or more objects.

In some embodiments, the device position data includes three-dimensional positional coordinates indicative of a position of the device, and three-dimensional angular coordinates indicative of an orientation of the device.

In some embodiments, the augmented reality logic is further configured to receive the three-dimensional angular coordinates from an Inertial Measurement Unit (IMU).

In some embodiments, the augmented reality logic is further configured to determine the three-dimensional positional coordinates based on one or more Radio Frequency (RF) signals received by the device.

In some embodiments, the augmented reality logic is further configured to display the augmented image on a display.

In some embodiments, the one or more objects are one or more electronic devices.

In some embodiments, an augmented reality logic may be configured to receive an image, determine device position data indicative of position and orientation of the device, identify one or more electronic devices visible in the image based on the device position data, obtain control data corresponding to the one or more electronic devices, and generate one or more control signals corresponding to the one or more electronic devices based on the control data.

In some embodiments, the augmented reality logic is further configured to transmit the one or more control signals to the one or more electronic devices.

In some embodiments, the augmented reality logic is further configured to superimpose the control data on the image to generate an augmented image and display the augmented image.

In some embodiments, an image may be received, and a device position data indicative of position and orientation of a device is determined, one or more objects visible in the image based on the device position data may be identified, control data corresponding to the one or more objects may be obtained, an augmented image by superimposing the control data on the image may be generated, and the augmented image may be displayed.

In some embodiments, one or more controllers associated with the one or more objects may be identified, one or more status requests to the one or more controllers may be transmitted, and the control data from the one or more controllers in response to the one or more status requests may be received.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network, in accordance with various embodiments of the disclosure;

FIG. 2 is a conceptual illustration of an Augmented Reality (AR) device, in accordance with various embodiments of the disclosure;

FIG. 3 is a conceptual illustration of an AR view in an AR device, in accordance with various embodiments of the disclosure;

FIG. 4 is a conceptual illustration of position and orientation of an AR device, in accordance with various embodiments of the disclosure;

FIG. 5 is a conceptual network diagram of various environments that an AR device manager may operate on a plurality of network devices, in accordance with various embodiments of the disclosure;

FIG. 6 is a flowchart depicting a process for displaying an augmented image, in accordance with various embodiments of the disclosure;

FIG. 7 is a flowchart depicting a process for generating control signals, in accordance with various embodiments of the disclosure;

FIG. 8 is a flowchart depicting a process for controlling electronic devices, in accordance with various embodiments of the disclosure; and

FIG. 9 is a conceptual block diagram of a device suitable for configuration with an augmented reality logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein provide an Augmented Reality (AR) device and an AR method to manage objects or electronic devices. In many embodiments, a device may implement an AR process. In some embodiments, the device can be an AR device. Examples of the AR device include, but are not limited to, smart glasses, AR glasses, AR headsets, AR goggles, or head mounted displays, etc. In certain embodiments, examples of the device include, but are not limited to, a smartphone, a tablet, or a personal computer, etc. The device can receive an image. In more embodiments, the device may be equipped with a camera to capture the image or to capture videos, in real-time or near-real time. In some more embodiments, the device may receive the image from an external source or an external device. In numerous embodiments, the device can retrieve the image from an internal memory or fetch the image from an external database. In many further embodiments, the image can be a frame in a video feed. The image may depict one or more objects. Examples of the objects may include network devices, such as but not limited to, switches, routers, or gateways, etc. More examples of the objects can also include connections between the devices, such as but not limited to, wires, cables, or optical fibers, etc. Further examples of the objects may include equipment or appliances, such as but not limited to, light bulbs, displays (for example, televisions or monitors), ceiling mounted devices such as projectors or smoke detectors, air conditioning systems, HVACs, or Wi-Fi Access Points (APs), etc. In still more embodiments, the objects can be Radio Frequency Identification (RFID) tags, Near-Field Communication (NFC) tags, QR codes, Bluetooth Low Energy (BLE) beacons, or barcodes etc. Some more examples of the objects include, but are not limited to, power supplies, wall plugs/outlets, generators, or batteries etc.

In a number of embodiments, the device can determine device position data. The device position data may include spatial data, including a position of the device and an orientation of the device. For the position of the device, the device position data may include three-dimensional coordinates, viz. x, y, z coordinates of the device. In some embodiments, for example, the x, y, z coordinates can indicate the position of the device in an indoor space, such as a room. In still more embodiments, the x, y, z coordinates can indicate the position of the device in an outdoor space. For the orientation of the device, the device position data may include three-dimensional angular coordinates, viz. θₓ, θ_{y}, θ_{z} angular coordinates of the device. In certain embodiments, for example, the θₓ, θ_{y}, θ_{z} angular coordinates can indicate the orientation, i.e., angles made by the device along x, y, z axes. In more embodiments, the device may determine the device position data by utilizing Wi-Fi positioning techniques such as trilateration/multilateration, Received Signal Strength Indication (RSSI) of Radio Frequency (RF) signals, Ultra-Wideband (UWB) positioning, fingerprinting, Angle of Arrival (AoA) or Time of Flight (ToF) etc. In some more embodiments, the device can determine the device position data based on data received from Inertial Measurement Unit (IMU), for example. For wearable devices, the orientation of the device may be indicative of a direction of a gaze of a user wearing the device. In that case, the image may be indicative of a Field of View (FOV) visible to the user.

In various embodiments, the device may detect the objects present in the image. In that, the device can detect one or more pixels in the image corresponding to the objects by implementing one or more image processing, object recognition, or computer vision techniques, for example. The device may determine spatial coordinates associated with the one or more pixels based on the device position data and image characteristics of the image. Examples of the image characteristics may include focal length, resolution, etc. of the image. The device can determine object position data based on the spatial coordinates associated with the one or more pixels corresponding to the objects. In some embodiments, for example, the object position data may indicate three-dimensional coordinates associated with the objects. Thereafter, the device may identify the detected objects. In certain embodiments, the device can identify the objects by accessing an object dentification database. The object identification database may include a mapping of the objects and their locations. The device can transmit an identification request to the object identification database. The identification request may include at least one of: the device position data or the object position data. The object identification database can retrieve object identifiers of the objects present in an area of space associated with the device position data and/or the object position data. The object identification database may transmit identification data to the device. The identification data may include information, such as but not limited to object identifiers, types of objects, or controllers associated with the objects, etc. The device can identify the objects based on the identification data. In numerous embodiments, the device may also identify the objects by scanning or processing QR codes, BLE beacons, barcodes, RFID tags, or NFC tags associated with the objects.

In additional embodiments, the device can determine one or more controllers associated with the objects (or electronic devices) based on the identification data. In some embodiments, for instance, when the object is a switch or a database, the device can determine a server or cloud server that is connected to the switch or the database. In certain embodiments, the device may be connected to the controllers by way of wired or wireless networks. In more embodiments, the device can communicate with the controllers through internet. The device can transmit a status request to a controller associated with an electronic device. In some more embodiments, for example, the status request may include an identifier (for example, Internet Protocol (IP) address or Media Access Control (MAC) address) associated with the electronic device, name of the electronic device, type of the electronic device, or other information indicated by the identification data corresponding to the electronic device. The controller may transmit control data to the device in response to the status request. The control data can be indicative of one or more parameters associated with the electronic device, such as but not limited to, power consumption, status (for example, whether the electronic device is ON/OFF or in a power saving mode, whether the device is online/offline, etc.), or other such parameters relevant to the electronic device. In examples where the object is a connector or a cable, the control data may indicate whether the connection is proper or functional, a speed of the connection, quality of the connection, etc. The device may superimpose the control data on the image to generate an augmented image. In some embodiments, for example, the device may utilize image processing or computer vision techniques to display the control data adjacent to a location of the electronic device in the image. The device can display the augmented image to the user.

In further embodiments, the device may receive biometric data corresponding to the user. In some embodiments, the device may be equipped with one or more biometric sensors, such as but not limited to a face recognition sensor, an iris recognition sensor, or a fingerprint sensor, etc. The biometric data may be generated by one or more biometric sensors when the user wears, handles, or interacts with the device. The device can authenticate the user based on the biometric data. The device may determine a user identifier (for example, name, username, or ID number) corresponding to the user. The device can further access an administrative database to determine a level of access authorized to the user. The administrative database may include user identifiers and corresponding authorizations, for example, access levels, etc. The device can transmit an access control request to the administrative database. The access control request may be indicative of the user identifier. The administrative database can transmit access control data in response to the access control request. In certain embodiments, for example, the access control data may be indicative of a portion of control data that is authorized to be accessed by the user. Thereafter, the device can select the portion of the control data that can be accessed by the user and superimpose the selected control data on the image to generate the augmented image. Thus, by restricting access to the control data, the device can ensure secure and selective access to different users of the device. In more embodiments, the device can utilize Artificial Intelligence (AI) or Machine Learning (ML) techniques to detect or identify the objects or electronic devices, to identify relevant control data, or to generate the augmented image.

In many more embodiments, the device can generate one or more control signals corresponding to the electronic device. In some embodiments, the device may receive an input from the user. In certain embodiments, for example, the device may receive a voice command, a gesture, or a touch, etc. from the user as the input. The device can generate the control signals based on the input received from the user. In more embodiments, the access control data may be indicative of whether the user is authorized to control the electronic device. In that case, the device can generate the control signals based on the input and the access control data. The device may transmit the control signal to the electronic device. In some more embodiments, the device can transmit the control signal to the controllers, or to any other devices associated with the electronic device, to relay the control signal to the electronic device. In numerous embodiments, the control signals may be indicative of changing the operational states (such as power saving modes, for example) of the electronic devices, switching the electronic devices ON/OFF, etc. In many further embodiments, the control signals can be indicative of changing power policies of the electronic devices.

Advantageously, the device of the present disclosure can facilitate easy control over physical objects such as the electronic devices. The device can select and display relevant control data in real-time or near-real time. The device may also facilitate access control for the control data, thereby providing secure access to different users. In power delivery infrastructure, the device can be utilized in to detect power losses. In data centers and communication networks, the device may be utilized to identify the switches that consume more power. Thus, the device can ease or simplify management of systems that include a large number of interconnected devices.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

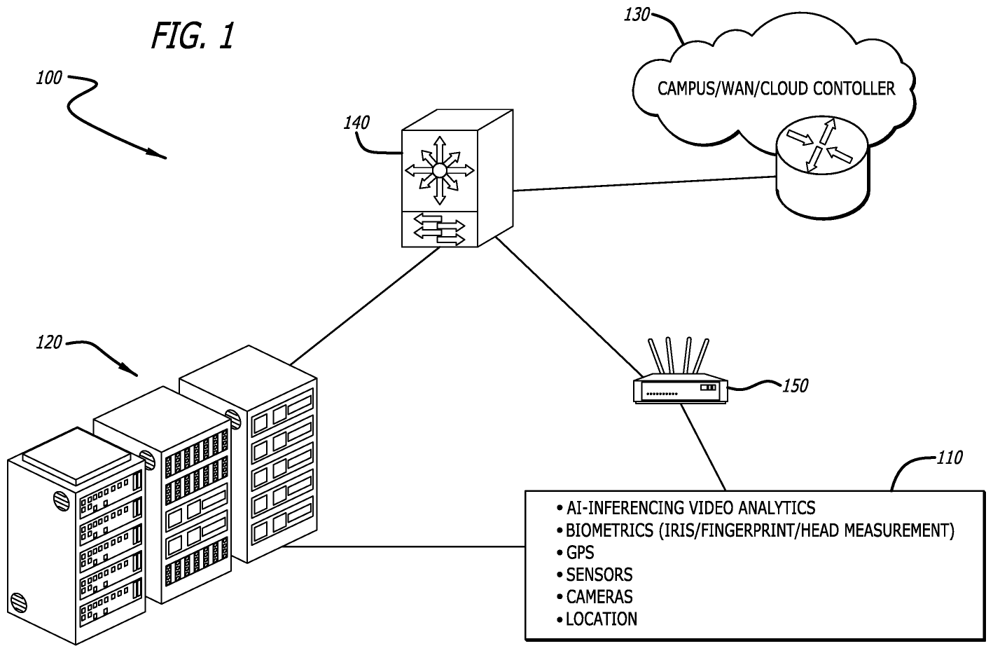

Referring to FIG. 1, a conceptual illustration of a network 100, in accordance with various embodiments of the disclosure is shown. In many embodiments, the network 100 may include an Augmented Reality (AR) device 110 and a device 120. The device 120 may be in communication with a cloud controller 130 via a switch 140. The AR device 110 can also be in communication with the cloud controller 130 via an Access Point (AP) 150 and the switch 140.

In a number of embodiments, the AR device 110 can implement an AR process. The AR device 110 may include cameras, biometric sensors, Global Positioning System (GPS) sensors, Wi-Fi chip, and may implement Artificial Intelligence (AI) video analytics. The AR device 110 can receive an image from the camera. The image may depict the device 120. The AR device 110 can detect the device 120 in the image. In that, the AR device 110 may detect one or more pixels in the image corresponding to the device 120 by implementing one or more image processing, object recognition, or computer vision techniques, for example. The AR device 110 can determine device position data, including a position and an orientation, of the AR device 110. The AR device 110 may determine the position by utilizing the GPS sensors. The position can include three-dimensional coordinates, viz. x, y, z coordinates of the AR device 110. The AR device 110 may determine the orientation by utilizing an Inertial Measurement Unit (IMU) sensor. The orientation can include three-dimensional angular coordinates, viz. θₓ, θ_{y}, θ_{z} angular coordinates of the AR device 110. Further, the AR device 110 can determine spatial coordinates associated with the one or more pixels corresponding to the device 120 based on the device position data and image characteristics, such as but not limited to, focal length, resolution, etc. of the image. The AR device 110 may determine object position data corresponding to the device 120 based on the spatial coordinates associated with the one or more pixels. In some embodiments, for example, the object position data may indicate three-dimensional coordinates associated with the device 120. The AR device 110 may transmit an identification request to an object identification database. The identification request can include the device position data and/or the object position data. The object identification database may transmit identification data to the AR device 110 in response to the identification request. The AR device 110 can determine a device identifier associated with the device 120 based on the identification data. The AR device 110 may identify a controller associated with the device 120 based on the identification data. In some embodiments, the controller may be the cloud controller 130. The AR device 110 can transmit a status request to the cloud controller 130. The status request may include the device identifier associated with the device 120. The cloud controller 130 can provide control data associated with the device 120. The AR device 110 may superimpose the control data on the image to generate an augmented image. The AR device 110 can display the augmented image to a user.

In various embodiments, the AR device 110 may receive biometric data of the user from the biometric sensor. The AR device 110 can authenticate the user based on the biometric data. The AR device 110 may transmit an access control request to an administrative database. The access control request may include a user identifier corresponding to the user. The administrative database can transmit access control data in response to the access control request. The AR device 110 may determine which control data is authorized to be displayed to the user based on the access control data. The AR device 110 can selectively superimpose the control data on the image based on the access control data.

In additional embodiments, the AR device 110 can receive an input from the user. The AR device 110 may generate a control signal based on the input. The AR device 110 can transmit the control signal to the device 120. In more embodiments, the AR device 110 can utilize AI or Machine Learning (ML) techniques to detect or identify the objects or electronic devices, to identify relevant control data, or to generate the augmented image.

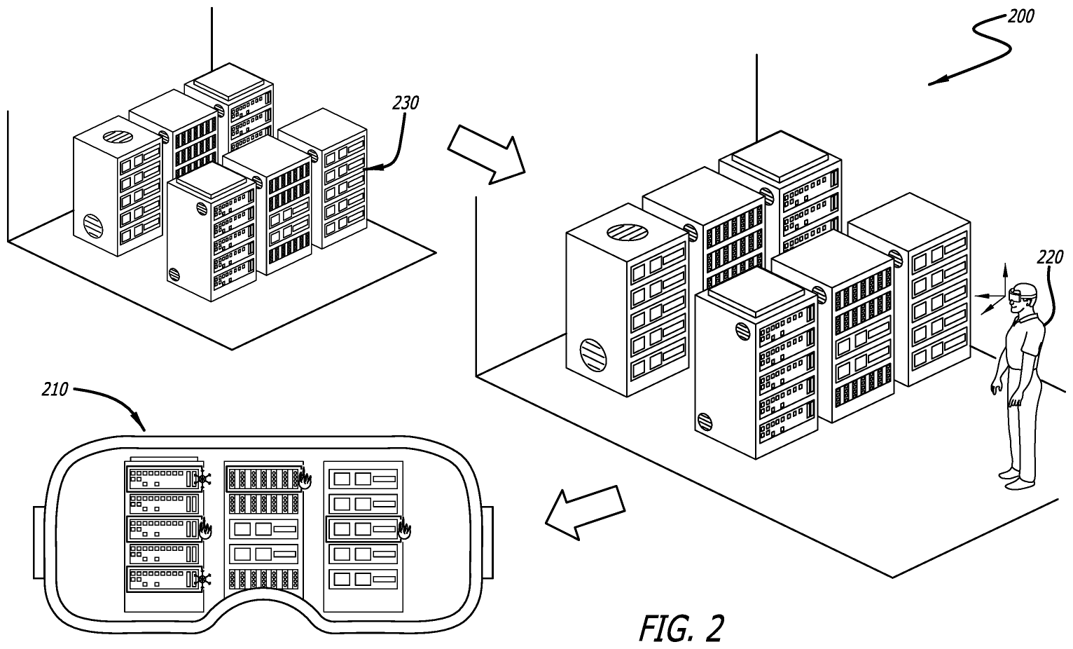

Although a specific embodiment for the network 100 for carrying out the various steps, processes, methods, and operations described herein is discussed with respect to FIG. 1, any of a variety of systems and/or processes may be utilized in accordance with embodiments of the disclosure. For example, the AR device 110 may be utilized to control and manage the device 120. The elements depicted in FIG. 1 may also be interchangeable with other elements of FIGS. 2-9 as required to realize a particularly desired embodiment.

Referring to FIG. 2, a conceptual illustration of an AR device 210, in accordance with various embodiments of the disclosure is shown. In many embodiments, the AR device 210 can be AR smart glasses. The AR device 210 may be worn by a user 220. The AR device 210 can capture an image 230 indicative of one or more objects or devices. The AR device 210 can determine device position data, including the position and the orientation, of the AR device 210. The AR device 210 may determine the position including three-dimensional coordinates, viz. x, y, z coordinates as shown in FIG. 2. The AR device 210 may also determine the orientation including three-dimensional angular coordinates, viz. θₓ, θ_{y}, θ_{z} angular coordinates as shown in FIG. 2.

In a number of embodiments, the AR device 210 may be utilized in a data center or a server room, or outdoors. The image 230, as shown in FIG. 2, may depict one or more switches mounted in stacks. Multiple stacks of switches may be located side by side. The switches and connections between the switches may look similar and complex. Therefore, it may be difficult for the user 220 to manually distinguish between the switches and identify the controllers associated with the switches. However, the AR device 210 can detect the switches, identify the switches and the corresponding controllers, and display relevant information related to the switches by way of the augmented image displayed in the AR device 210. Therefore, the AR device 210 may simplify the process of controlling, maintaining, and managing the switches.

Although a specific embodiment for the AR device 210 for carrying out the various steps, processes, methods, and operations described herein is discussed with respect to FIG. 2, any of a variety of systems and/or processes may be utilized in accordance with embodiments of the disclosure. For example, the AR device 210 may be utilized in digital infrastructures including a large number of interconnected devices. The elements depicted in FIG. 2 may also be interchangeable with other elements of FIG. 1 and FIGS. 3-9 as required to realize a particularly desired embodiment.

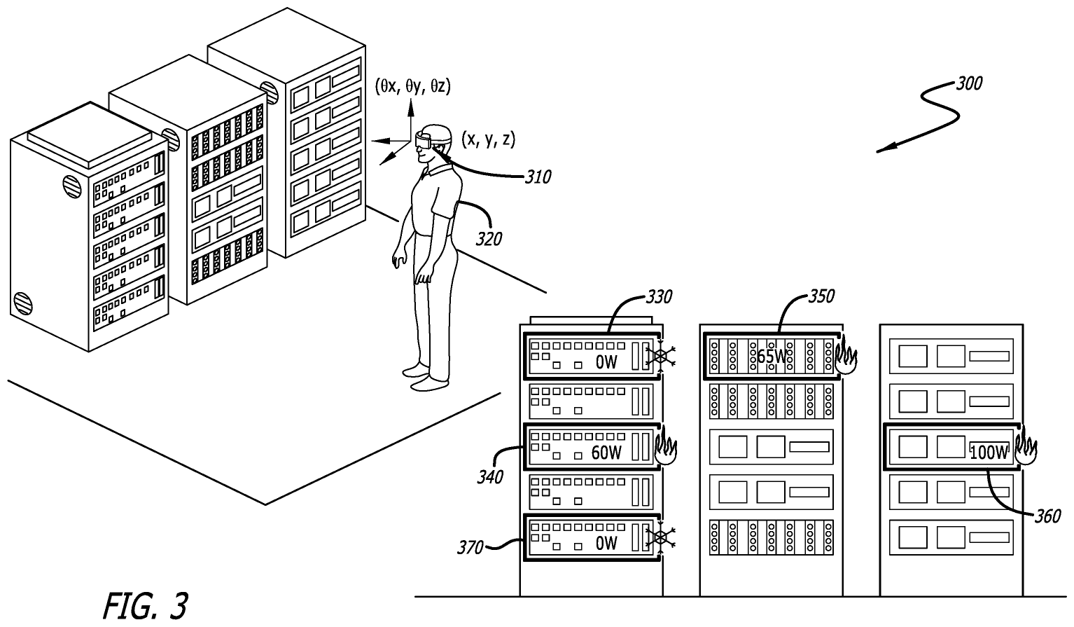

Referring to FIG. 3, a conceptual illustration of an AR view in an AR device 310, in accordance with various embodiments of the disclosure is shown. In many embodiments, the AR device can be worn by the user 320. The AR device 310 can determine the device position data. The device position data may include spatial data, including the position of the AR device 310 and the orientation of the AR device 310. For the position of the AR device 310, the device position data may include three-dimensional coordinates, viz. x, y, z coordinates of the AR device 310. In some embodiments, for example, the x, y, z coordinates can indicate the position of the AR device 310 in an indoor space, such as a room. In still more embodiments, the x, y, z coordinates can indicate the position of the AR device 310 in an outdoor space. For the orientation of the AR device 310, the device position data may include three-dimensional angular coordinates, viz. θₓ, θ_{y}, θ_{z} angular coordinates of the AR device 310. In certain embodiments, for example, the θₓ, θ_{y}, θ_{z} angular coordinates can indicate the orientation, i.e., angles made by the AR device 310 along x, y, z axes. In more embodiments, the AR device 310 may determine the device position data by utilizing Wi-Fi positioning techniques such as trilateration/multilateration, Received Signal Strength Indication (RSSI) of Radio Frequency (RF) signals, Ultra-Wideband (UWB) positioning, fingerprinting, Angle of Arrival (AoA) or Time of Flight (ToF) etc. In some more embodiments, the AR device 310 can determine the device position data based on data received from the IMU, for example. The orientation of the AR device 310 may be indicative of a direction of a gaze of the user 320 wearing the device. The image may be indicative of a Field of View (FOV) visible to the user 320. For example, in FIG. 3, the x, y, z coordinates may be indicative of which stack of switches are being viewed by the user 320 and the θₓ, θ_{y}, θ_{z}, angular coordinates may be indicative of which switches within the stack are being viewed by the user 320.

In a number of embodiments, the AR device 310 can detect the first through fifth devices 330, 340, 350, 360, and 370 in the FOV of the user 320. In some embodiments, the AR device 310 can also identify connections, such as wires, between the first through fifth devices 330, 340, 350, 360, and 370. The AR device 310 may further identify the first through fifth devices 330, 340, 350, 360, and 370 and the controllers associated with the first through fifth devices 330, 340, 350, 360, and 370. In certain embodiments, for instance, each device of the first through fifth devices 330, 340, 350, 360, and 370 may be associated with a different controller. The AR device 310 can retrieve the control data associated with each device of the first through fifth devices 330, 340, 350, 360, and 370. In more embodiments, the control data, as shown in FIG. 3, may be indicative of the power consumption of the first through fifth devices 330, 340, 350, 360, and 370. In more examples, the control data may be indicative of whether the first through fifth devices 330, 340, 350, 360, and 370 are ON/OFF or in a power saving mode, or whether the first through fifth devices 330, 340, 350, 360, and 370 are online/offline, etc. For the connectors or cables, the control data may indicate whether the connection is proper or functional, a speed of the connection, quality of the connection, etc. The AR device 310 may superimpose the control data on the image to generate the augmented image. The AR device 310 may utilize image processing or computer vision techniques to display the control data adjacent to locations of corresponding first through fifth devices 330, 340, 350, 360, and 370 in the image. For example, as shown in FIG. 3, the control data may be displayed in form of boxes enclosing the corresponding first through fifth devices 330, 340, 350, 360, and 370 with an indication of power consumption or temperature of the first through fifth devices 330, 340, 350, 360, and 370. The AR device 310 can display the augmented image to the user 320.

Although a specific embodiment for the AR device 310 for carrying out the various steps, processes, methods, and operations described herein is discussed with respect to FIG. 3, any of a variety of systems and/or processes may be utilized in accordance with embodiments of the disclosure. For example, the AR device 310 may identify and display relevant control data in a dynamic and interactive format. The elements depicted in FIG. 3 may also be interchangeable with other elements of FIGS. 1-2 and FIGS. 4-9 as required to realize a particularly desired embodiment.

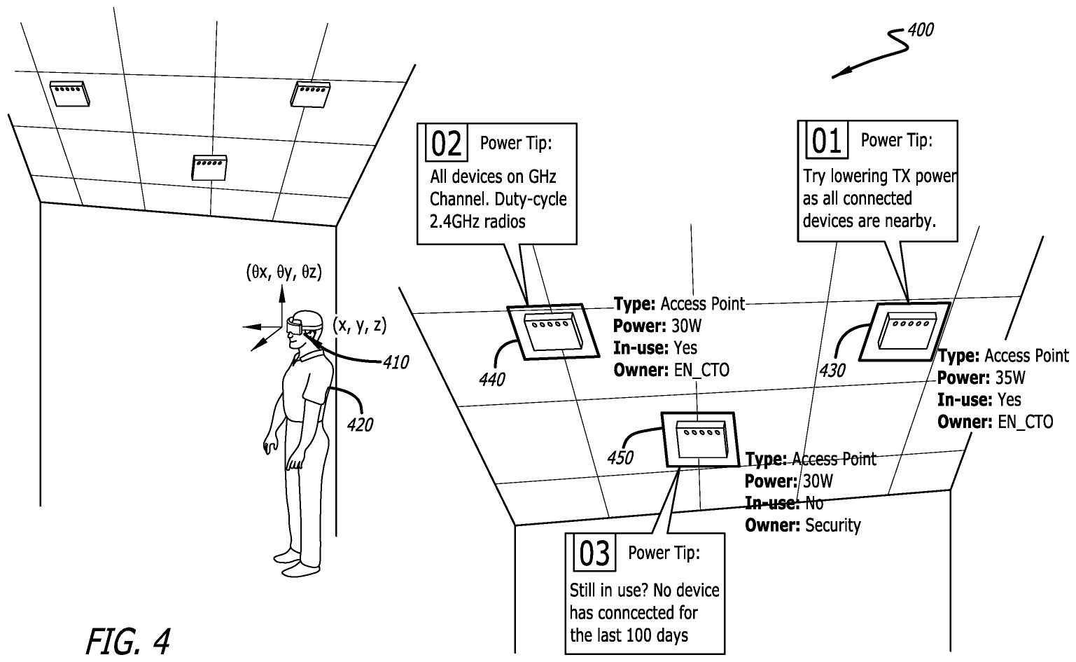

Referring to FIG. 4, a conceptual illustration of the position and the orientation of an AR device 410, in accordance with various embodiments of the disclosure is shown. In many embodiments, the AR device 410 can be utilized to inspect first through third ceiling mounted devices 430, 440, and 450 (also referred to as first through third devices 430, 440, and 450 with reference to FIG. 4) which may be difficult to physically access by a user 420. The AR device 410 can identify the first through third devices 430, 440, and 450 and retrieve relevant control data corresponding to the first through third devices 430, 440, and 450. In some embodiments, for example, the AR device 410 may retrieve different type of control data for each device of the first through third devices 430, 440, and 450.

In a number of embodiments, for example, the AR device 410 may suggest possible actions based on the control data corresponding to the first through third devices 430, 440, and 450. For instance, for the first device 430, the AR device 410 may display the control data such as type, power consumption, operational status, and owner of the first device 430. The AR device 410 may utilize AI/ML techniques to generate a first suggested action corresponding to the first device 430 based on the control data. For instance, as shown in FIG. 4, the AR device 410 may provide the first suggestion of reducing transmission power of the first device 430 as one or more user devices connected to the first device 430 are located at short distances. The first suggestion may be an interactive display element that facilitates the user 420 to generate a first control signal indicative of reducing transmission power of the first device 430. Upon receiving the input from the user 420, the AR device 410 may generate and transmit the first control signal to the first device 430. Similarly, the AR device 410 may display the control data such as type, power consumption, operational status, and owner of the second device 440. The AR device 410 may utilize AI/ML techniques to generate a second suggested action corresponding to the second device 440 based on the control data. For instance, as shown in FIG. 4, the AR device 410 may provide the second suggestion of switching the second device 440 to 5 GHz Wi-Fi band as all user devices connected to the second device 440 are connected on the 5 GHz band. The second suggestion may also be an interactive display element that facilitates the user 420 to generate a second control signal indicative of switching the second device 440 to 5 GHz Wi-Fi band. Upon receiving the input from the user 420, the AR device 410 may generate and transmit the second control signal to the second device 440. Similarly, the AR device 410 may display the control data such as type, power consumption, operational status, and owner of the third device 450. The AR device 410 may utilize AI/ML techniques to generate a third suggested action corresponding to the third device 450 based on the control data. For instance, as shown in FIG. 4, the AR device 410 may provide the third suggestion of switching off the third device 450 as no user devices have connected to the third device 450 for a long period of time, i.e., the third device 450 is not being used. The third suggestion can also be an interactive display element that facilitates the user 420 to generate a third control signal indicative of switching off the third device 450. Upon receiving the input from the user 420, the AR device 410 may generate and transmit the third control signal to the third device 450.

Although a specific embodiment for the AR device 410 for carrying out the various steps, processes, methods, and operations described herein is discussed with respect to FIG. 4, any of a variety of systems and/or processes may be utilized in accordance with embodiments of the disclosure. For example, the AR device 410 may intelligently generate and display suggestions or possible actions that can be implemented for the detected devices. The elements depicted in FIG. 4 may also be interchangeable with other elements of FIGS. 1-3 and FIGS. 5-9 as required to realize a particularly desired embodiment.

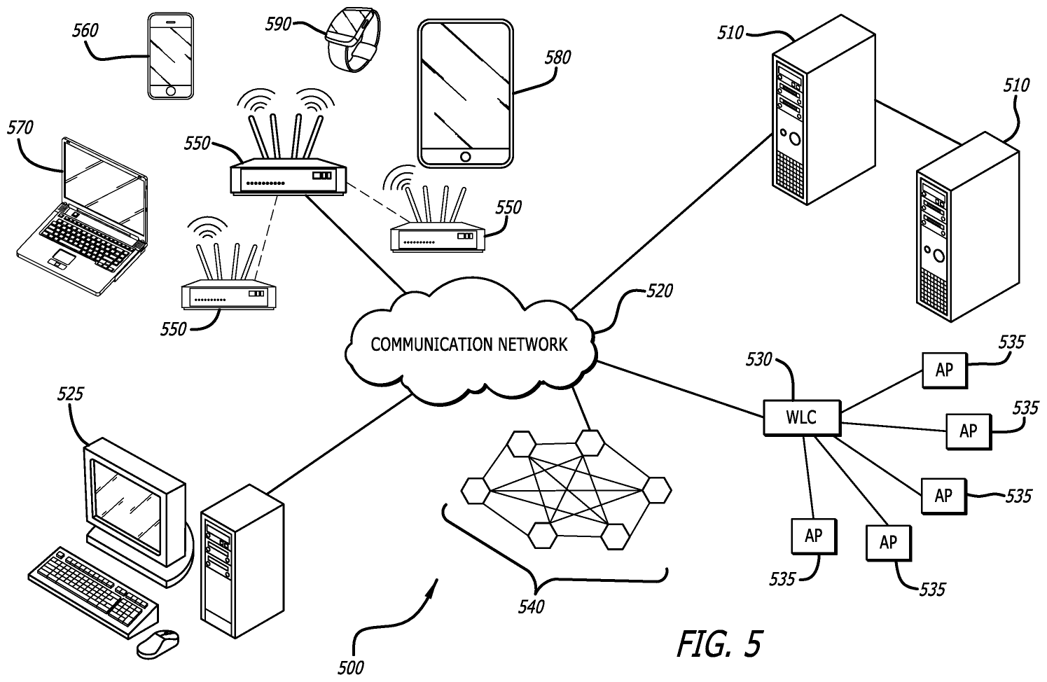

Referring to FIG. 5, a conceptual network diagram 500 of various environments that an AR device manager may operate on a plurality of network devices, in accordance with various embodiments of the disclosure is shown. Those skilled in the art will recognize that the AR device manager can be comprised of various hardware and/or software deployments and can be configured in a variety of ways. In many embodiments, the AR device manager can be configured as a standalone device, exist as a logic in another network device, be distributed among various network devices operating in tandem, or remotely operated as part of a cloud-based network management tool. In further embodiments, one or more servers 510 can be configured with or otherwise operate the AR device manager. In many embodiments, the AR device manager may operate on one or more servers 510 connected to a communication network 520. The communication network 520 can include wired networks or wireless networks. In many embodiments, the communication network 520 may be a Wi-Fi network operating on various frequency bands, such as, 2.4 GHz, 5 GHZ, or 6 GHz. In further embodiments, the AR device manager may operate on the servers 510. The AR device manager can be provided as a cloud-based service that can service remote networks, such as, but not limited to a deployed network 540. In many embodiments, the AR device manager can be a logic that detects and controls one or more devices or network devices by utilizing AR techniques.

However, in additional embodiments, the AR device manager may be operated as a distributed logic across multiple network devices. In the embodiment depicted in FIG. 5, a plurality of APs 550 can operate as the AR device manager in a distributed manner or may have one specific device operate as the AR device manager for all of the neighboring or sibling APs 550. The APs 550 facilitate Wi-Fi connections for various electronic devices, such as but not limited to mobile computing devices including laptop computers 570, cellular phones 560, portable tablet computers 580 and wearable computing devices 590.

In further embodiments, the AR device manager may be integrated within another network device. In the embodiment depicted in FIG. 5, a wireless LAN controller (WLC) 530 may have an integrated AR device manager that the WLC 530 can use to control and manage various APs 535 that the WLC 530 is connected to, either wired or wirelessly. In still more embodiments, a personal computer 525 may be utilized to access and/or manage various aspects of the AR device manager, either remotely or within the network itself. In the embodiment depicted in FIG. 5, the personal computer 525 communicates over the communication network 520 and can access the AR device manager of the servers 510, or the network APs 550, or the WLC 530.

Although a specific embodiment for various environments that the AR device manager may operate on a plurality of network devices suitable for carrying out the various steps, processes, methods, and operations described herein is discussed with respect to FIG. 5, any of a variety of systems and/or processes may be utilized in accordance with embodiments of the disclosure. In many non-limiting examples, the AR device manager may be provided as a device or software separate from the network devices or the AR device manager may be integrated into the network devices. The elements depicted in FIG. 5 may also be interchangeable with other elements of FIGS. 1-4 and 6-9 as required to realize a particularly desired embodiment.

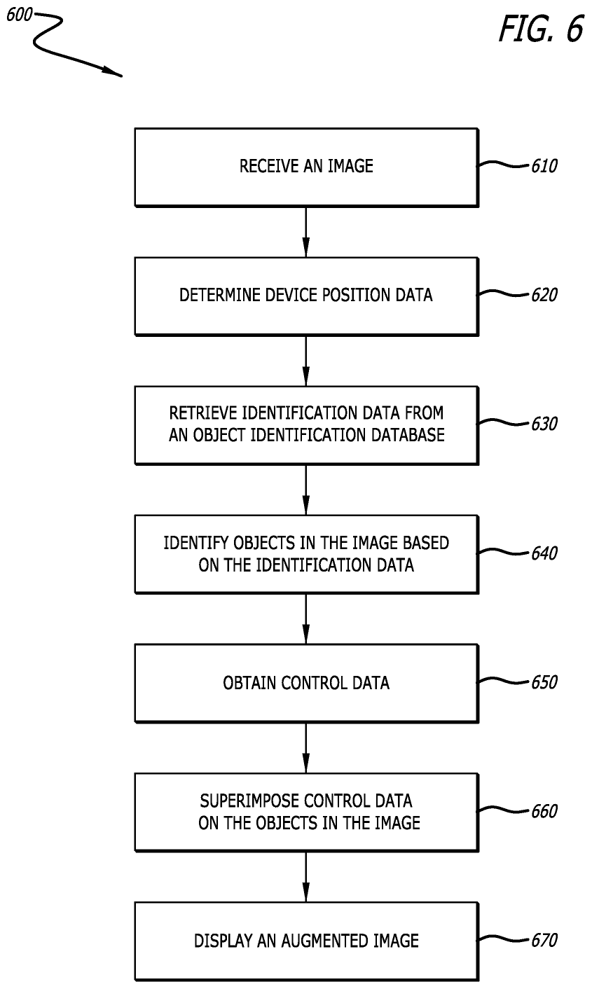

Referring to FIG. 6, a flowchart depicting a process 600 for displaying the augmented image, in accordance with various embodiments of the disclosure is shown. In many embodiments, the process 600 can receive the image (block 610). In some embodiments, the process 600 may be an AR device management process. In certain embodiments, the process 600 can be implemented by the AR device. In further embodiments, examples of the AR device can include, but are not limited to, smart glasses, AR glasses, AR headsets, AR goggles, or head mounted displays, etc. In more embodiments, the process 600 may be implemented by various types of devices, such as but not limited to, a smartphone, a tablet, or a personal computer etc. In some more embodiments, the devices may be equipped with a camera to capture the image or to capture videos, in real-time or near-real time. In numerous embodiments, the process 600 may receive the image from an external source or an external device. In many further embodiments, the process 600 can retrieve the image from an internal memory or fetch the image from an external database. In still more embodiments, the image can be a frame in a video feed. In many additional embodiments, the image may depict one or more objects. In still further embodiments, examples of the objects may include network devices, such as but not limited to, switches, routers, or gateways, etc. In still more embodiments, more examples of the objects can also include connections between the devices, such as but not limited to, wires, cables, or optical fibers, etc. In many further embodiments, further examples of the objects may include equipment or appliances, such as but not limited to, light bulbs, displays (for example, televisions or monitors), ceiling mounted devices such as projectors or smoke detectors, air conditioning systems, HVACs, or Wi-Fi Access Points (APs), etc. In still more embodiments, the objects can be Radio Frequency Identification (RFID) tags, Near-Field Communication (NFC) tags, QR codes, Bluetooth Low Energy (BLE) beacons, or barcodes etc. In many additional embodiments, some more examples of the objects may include, but are not limited to, power supplies, wall plugs/outlets, generators, or batteries etc.

In a number of embodiments, the process 600 may determine the device position data (block 620). In some embodiments, the device position data may include spatial data, including the position of the AR device and the orientation of the AR device. In further embodiments, for the position of the device, the device position data may include three-dimensional coordinates, viz. x, y, z coordinates of the AR device. In certain embodiments, for example, the x, y, z coordinates can indicate the position of the AR device in an indoor space, such as a room. In still more embodiments, the x, y, z coordinates can indicate the position of the AR device in an outdoor space. In still further embodiments, for the orientation of the device, the device position data may include three-dimensional angular coordinates, viz. θₓ, θ_{y}, θ_{z} angular coordinates of the AR device. In more embodiments, for example, the θₓ, θ_{y}, θ_{z} angular coordinates can indicate the orientation, i.e., angles made by the AR device along x, y, z axes. In some more embodiments, the process 600 may determine the device position data by utilizing Wi-Fi positioning techniques such as trilateration/multilateration, RSSI fingerprinting, UWB positioning, AoA or ToF etc. In numerous embodiments, the process 600 can determine the device position data based on data received from the IMU, for example. In many further embodiments, for wearable devices, the orientation of the AR device may be indicative of the direction of the gaze of the user wearing the AR device. In still more embodiments, in that case, the image may be indicative of the FOV visible to the user. In many further embodiments, the process 600 may detect one or more pixels in the image corresponding to the objects by implementing one or more image processing, object recognition, or computer vision techniques, for example. In some embodiments, the process 600 can determine spatial coordinates associated with the one or more pixels based on the device position data and image characteristics of the image. In certain embodiments, examples of the image characteristics may include focal length, resolution, etc. of the image. In more embodiments, the process 600 may determine object position data based on the spatial coordinates associated with the one or more pixels corresponding to the objects. In some more embodiments, for example, the object position data may indicate three-dimensional coordinates associated with the objects.

In various embodiments, the process 600 can retrieve the identification data from the object identification database (block 630). In some embodiments, the process 600 can identify the objects by accessing the object dentification database. In certain embodiments, the object identification database may include a mapping of the objects and their locations. In more embodiments, the process 600 can transmit the identification request to the object identification database. In some more embodiments, the identification request may include the device position data and/or the object position data. In numerous embodiments, the object identification database can retrieve the object identifiers of the objects present in an area of space associated with the device position data and/or the object position data. In many further embodiments, the object identification database may transmit the identification data to the process 600 implemented by the AR device. In still more embodiments, the identification data may include information, such as but not limited to object identifiers, types of objects, or controllers associated with the objects, etc. In many additional embodiments, the process 600 can identify the objects based on the identification data. In still further embodiments, the process 600 may also identify the objects by scanning or processing QR codes, BLE beacons, barcodes, RFID tags, or NFC tags associated with the objects.

In additional embodiments, the process 600 can identify the objects in the image based on the identification data (block 640). In some embodiments, the process 600 can determine the controllers associated with the objects (or electronic devices) based on the identification data. In certain embodiments, for instance, when the object is a switch or a database, the process 600 can determine the server or cloud server that is connected to the switch or the database. In more embodiments, the AR device implementing the process 600 may be connected to the controllers by way of wired or wireless networks.

In further embodiments, the process 600 may obtain the control data (block 650). In some embodiments, the process 600 can communicate with the controllers through internet. In certain embodiments, the process 600 can transmit the status request to the controller associated with the electric device. In some more embodiments, for example, the status request may include an identifier (for example, IP address or MAC address) associated with the electronic device, name of the electronic device, type of the electronic device, or other information indicated by the identification data corresponding to the electronic device. In numerous embodiments, the controller may transmit control data to the process 600 implemented by the AR device in response to the status request. In many further embodiments, the control data can be indicative of one or more parameters associated with the electronic device, such as but not limited to, power consumption, status (for example, whether the electronic device is ON/OFF or in a power saving mode, whether the device is online/offline, etc.), or other such parameters relevant to the electronic device.

In many more embodiments, the process 600 can superimpose the control data on the objects in the image (block 660). In some embodiments, the process 600 may utilize image processing or computer vision techniques to display the control data adjacent to the location of the electronic device in the image. In certain embodiments, the process 600 can generate the augmented image including the objects and the corresponding control data.

In many additional embodiments, the process 600 may display the augmented image (block 670). In some embodiments, the augmented image can be displayed in real-time or near-real time. In certain embodiments, the process 600 may display the augmented image in an interactive format, thereby allowing the user to select or interact with the objects and/or the control data.

Although a specific embodiment for the process 600 for displaying the augmented image for carrying out the various steps, processes, methods, and operations described herein is discussed with respect to FIG. 6, any of a variety of systems and/or processes may be utilized in accordance with embodiments of the disclosure. For example, the process 600 may be utilized to directly interact with Internet of Things (IoT) enabled devices or with devices powered by Power over Ethernet (POE). The elements depicted in FIG. 6 may also be interchangeable with other elements of FIGS. 1-5 and FIGS. 7-9 as required to realize a particularly desired embodiment.

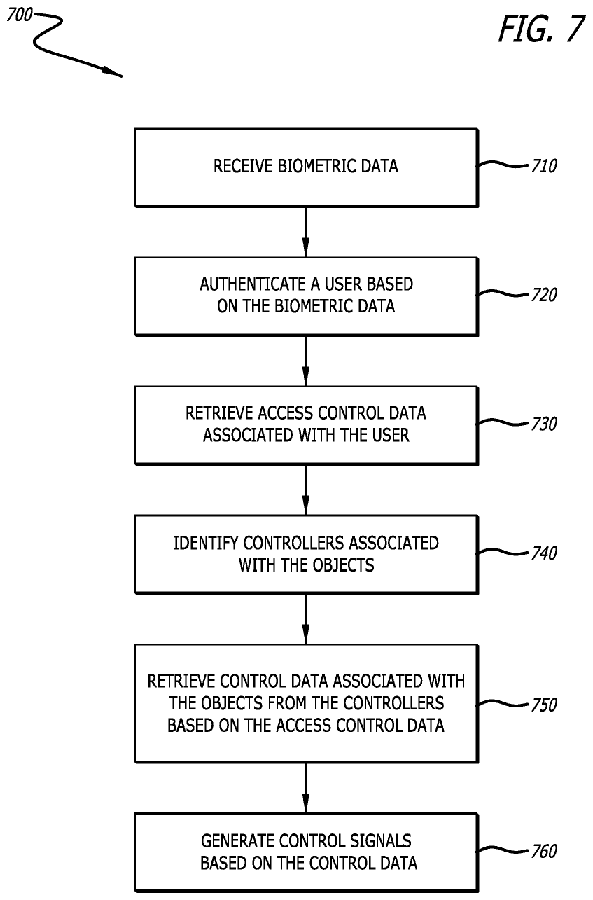

Referring to FIG. 7, a flowchart depicting a process 700 for generating the control signals, in accordance with various embodiments of the disclosure is shown. In many embodiments, the process 700 can receive the biometric data (block 710). In some embodiments, the process 700 may be implemented by the AR device comprising the biometric sensors, such as but not limited to a face recognition sensor, an iris recognition sensor, or a fingerprint sensor, etc. In certain embodiments, the biometric data may be generated by the biometric sensors when the user wears, handles, or interacts with the device.

In a number of embodiments, the process 700 may authenticate the user based on the biometric data (block 720). In some embodiments, the process 700 may determine the user identifier (for example, name, username, or ID number) corresponding to the user. In certain embodiments, the process 700 can uniquely identify and authenticate different users using the same AR device.

In various embodiments, the process 700 can retrieve the access control data associated with the user (block 730). In some embodiments, the process 700 can further access the administrative database to determine the level of access authorized to the user. In certain embodiments, the administrative database may include user identifiers and corresponding authorizations, for example, access levels, etc. In more embodiments, the process 700 can transmit the access control request to the administrative database. In some more embodiments, the access control request may be indicative of the user identifier. In numerous embodiments, the administrative database can transmit the access control data in response to the access control request.

In additional embodiments, the process 700 may identify the controllers associated with the objects (block 740). In some embodiments, the process 700 can identify the controllers based on the identification data. In certain embodiments, the process 700 may transmit the status request to the controller. In more embodiments, the status request may be indicative of the object identifier. In some more embodiments, the controller may transmit the control data associated with the object.

In further embodiments, the process 700 can retrieve the control data associated with the objects from the controllers based on the access control data (block 750). In some embodiments, the access control data may be indicative of the portion of control data that is authorized to be accessed by the user. In certain embodiments, the process 700 can select the portion of the control data that can be accessed by the user and superimpose the selected control data on the image to generate the augmented image.

In many more embodiments, the process 700 may generate the control signals based on the control data (block 760). In some embodiments, the process 700 may receive the input from the user. In certain embodiments, for example, the process 700 may receive the voice command, the gesture, or the touch, etc. from the user as the input. In more embodiments, the process 700 can generate the control signals based on the input received from the user. In numerous embodiments, when the objects are the electronic devices, the control signals may be indicative of changing the operational states (such as power saving modes, for example) of the electronic devices, switching the electronic devices ON/OFF, etc. In many further embodiments, the control signals can be indicative of changing power policies of the electronic devices.

Although a specific embodiment for the process 700 for generating the control signals for carrying out the various steps, processes, methods, and operations described herein is discussed with respect to FIG. 7, any of a variety of systems and/or processes may be utilized in accordance with embodiments of the disclosure. For example, the process 700 may be utilized for wirelessly generating the control signals through the AR device. The elements depicted in FIG. 7 may also be interchangeable with other elements of FIGS. 1-6 and FIGS. 8-9 as required to realize a particularly desired embodiment.

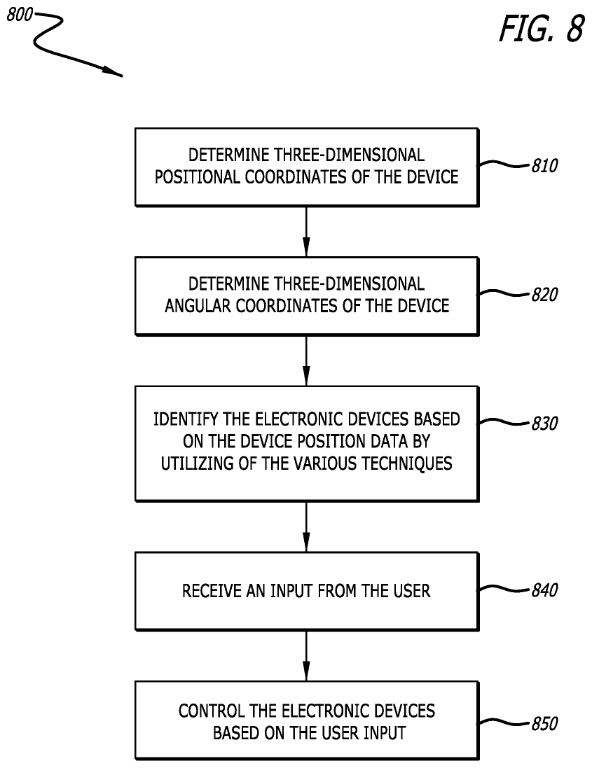

Referring to FIG. 8, a flowchart depicting a process 800 for controlling the electronic devices, in accordance with various embodiments of the disclosure is shown. In many embodiments, the process 800 may determine the three-dimensional positional coordinates, viz. x, y, z coordinates of the AR device (block 810). In some embodiments, the process 800 can be implemented by the AR device. In certain embodiments, the process 800 may utilize the Wi-Fi positioning techniques such as trilateration/multilateration, RSSI fingerprinting, UWB positioning, AoA, or ToF etc. In more embodiments, the process 800 can determine the position of the AR device in the indoor space, such as the room, or any outdoor space.

In a number of embodiments, the process 800 can determine the three-dimensional angular coordinates of the AR device (block 820). In some embodiments, the process 800 can determine the device position data based on the data received from IMU, for example. In certain embodiments, for example, the θₓ, ƒ_{y}, θ_{z} angular coordinates can indicate the orientation, i.e., angles made by the AR device along x, y, z axes.

In various embodiments, the process 800 may identify the electronic devices based on the device position data by utilizing of the various techniques (block 830). In some embodiments, the process 800 can identify the electronic devices by obtaining the identification data from the object identification database. In certain embodiments, the process 800 may also identify the objects by scanning or processing barcodes, QR codes, RFID tags, or NFC tags associated with the objects.

In additional embodiments, the process 800 can receive the input from the user (block 840). In some embodiments, the process 800 may receive the input when the user interacts with the interactive augmented image. In certain embodiments, the process 800 can receive the voice command, the gesture, or the touch, etc. from the user as the input.

In further embodiments, the process 800 may control the electronic devices based on the user input (block 850). In some embodiments, the process 800 can generate the control signals based on the input. In certain embodiments, the process 800 may transmit the control signals to the electronic device.

Although a specific embodiment for the process 800 for controlling the electronic devices for carrying out the various steps, processes, methods, and operations described herein is discussed with respect to FIG. 8, any of a variety of systems and/or processes may be utilized in accordance with embodiments of the disclosure. For example, the process 800 may wirelessly control the electronic devices. The elements depicted in FIG. 8 may also be interchangeable with other elements of FIGS. 1-7 and FIG. 9 as required to realize a particularly desired embodiment.

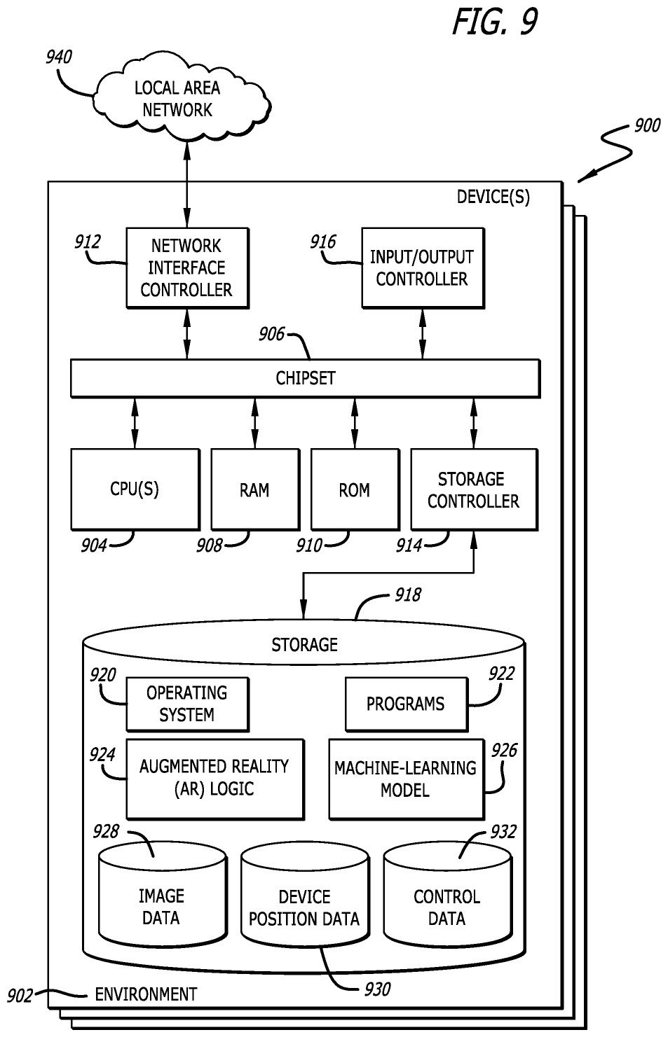

Referring to FIG. 9, a conceptual block diagram of a device 900 suitable for configuration with an augmented reality logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, image data 928, device position data 930, and control data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The image data 928 can include the images obtained by the camera coupled with the device 900. The image data 928 can also include the augmented images generated by the device 900. The device position data 930 may store the position and orientation of the device 900. The control data 932 can store the control data associated with the objects in the image. The control data 932 can be received by the device 900 from the controllers associated with the objects.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to the device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include an augmented reality logic 924. The augmented reality logic 924 can be configured to perform one or more of the various steps, processes, operations, and/or other methods that are described above. Often, the augmented reality logic 924 can be a set of instructions stored within a non-volatile memory that, when executed by the processor(s)/controller(s) 904 can carry out these steps, etc. In some embodiments, the augmented reality logic 924 may be a client application that resides on a network-connected device, such as, but not limited to, a server, switch, personal or mobile computing device in a single or distributed arrangement. The augmented reality logic 924 can generate the augmented images based on the captured images, the control data, and the access data.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the image data 928, the device position data 930, and the control data 932 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for the device 900 suitable for configuration with the augmented reality logic 924 for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
an augmented reality logic, configured to:
receive an image;
determine device position data;
identify one or more objects visible in the image based on the device position data;
obtain control data corresponding to the one or more objects; and
generate an augmented image by superimposing the control data on the image.

2. The device of claim 1, wherein the augmented reality logic is further configured to:
access an object identification database;
transmit an identification request indicative of the device position data to the object identification database;
receive identification data from the object identification database in response to the identification request; and
identify the one or more objects visible in the image based on the identification data.

3. The device of claim 2, wherein the augmented reality logic is further configured to:
receive biometric data;
authenticate a user of the device based on the biometric data; and
determine a user identifier corresponding to the user.

4. The device of claim 3, wherein the augmented reality logic is further configured to:
access an administrative database;
transmit an access control request indicative of the user identifier to the administrative database; and
receive access control data from the administrative database in response to the access control request.

5. The device of claim 4, wherein the augmented reality logic is further configured to:
identify one or more controllers associated with the one or more objects;
transmit one or more status requests to the one or more controllers; and
receive the control data from the one or more controllers in response to the one or more status requests.

6. The device of claim 5, wherein the one or more status requests are indicative of:
the identification data corresponding to the one or more objects; and
the access control data corresponding to the user.

7. The device of claim 6, wherein the identification data is indicative of one or more of:
three-dimensional positional coordinates corresponding to the one or more objects;
object identifiers corresponding to the one or more objects; or
controllers associated with the one or more objects.

8. The device of claim 7, wherein the augmented reality logic is further configured to generate one or more control signals corresponding to the one or more objects based on the control data.

9. The device of claim 8, wherein the augmented reality logic is further configured to:
receive an input from the user; and
generate the one or more control signals based on the control data and the input.

10. The device of claim 9, wherein the augmented reality logic is further configured to transmit the one or more control signals to the one or more objects.

11. The device of claim 1, wherein the device position data includes:
three-dimensional positional coordinates indicative of a position of the device; and
three-dimensional angular coordinates indicative of an orientation of the device.

12. The device of claim 11, wherein the augmented reality logic is further configured to receive the three-dimensional angular coordinates from an Inertial Measurement Unit (IMU).

13. The device of claim 11, wherein the augmented reality logic is further configured to determine the three-dimensional positional coordinates based on one or more Radio Frequency (RF) signals received by the device.

14. The device of claim 1, wherein the augmented reality logic is further configured to display the augmented image on a display.

15. The device of claim 1, wherein the one or more objects are one or more electronic devices.

16. A device, comprising:
a processor;
a memory communicatively coupled to the processor; and
an augmented reality logic, configured to:
receive an image;
determine device position data indicative of position and orientation of the device;
identify one or more electronic devices visible in the image based on the device position data;
obtain control data corresponding to the one or more electronic devices; and
generate one or more control signals corresponding to the one or more electronic devices based on the control data.

17. The device of claim 16, wherein the augmented reality logic is further configured to transmit the one or more control signals to the one or more electronic devices.

18. The device of claim 16, wherein the augmented reality logic is further configured to:
superimpose the control data on the image to generate an augmented image; and
display the augmented image.

19. A method comprising:
receiving an image;
determining device position data indicative of position and orientation of a device;
identifying one or more objects visible in the image based on the device position data;
obtaining control data corresponding to the one or more objects;
generating an augmented image by superimposing the control data on the image; and
displaying the augmented image.

20. The method of claim 19, further comprising:
identifying one or more controllers associated with the one or more objects;
transmitting one or more status requests to the one or more controllers; and
receiving the control data from the one or more controllers in response to the one or more status requests.
